(19) United States
(12) Patent Application Publication
(10) Pub. No.: US 2024/0241775 A1
(43) Pub. Date: Jul. 18, 2024

(54) METHODS AND APPARATUS TO ENABLE INTER-PROCESS COMMUNICATION USING A SHARED MEMORY WITH A SHARED HEAP

(71) Applicant: Intel Corporation, Santa Clara, CA (US)

(72) Inventors: Joseph Jacob Grecco, Saddle Brook, NJ (US); Kianoosh Zandifar, Beaverton, OR (US); Kimberly Malone, San Jose, CA (US); Scott Peterson, Beaverton, OR (US)

(21) Appl. No.: 18/618,844

(22) Filed: Mar. 27, 2024

(51) Int. Cl. G06F 9/54

(52) U.S. Cl. CPC G06F 9/544

(57) ABSTRACT

Disclosed examples implement inter-process communication using a shared memory with a shared heap. Disclosed examples send a request from a first process to a second process, the request to cause allocation of a shared heap in shared memory; determine a first virtual address range of the first process for the shared heap in the shared memory based on the first virtual address range matching a second virtual address range from the second process in the shared memory; and write information from the first process to the shared heap, the information to be accessed by the second process from the shared heap.

### FIELD OF THE DISCLOSURE

This disclosure relates generally to inter-process communication and, more particularly, to inter-process communication using a shared memory with a shared heap.

### BACKGROUND

In recent years, inter-process communication (IPC) has been carried out via complex communication mechanisms. IPC is used to send communications between processes. Two executing processes may transfer data between one another using IPC to work cooperatively to analyze and/or process the data.

### BRIEF DESCRIPTION OF THE DRAWINGS

FIG. 1 is a block diagram of an example environment in which an example distributed heap manager operates to allocate a shared heap in a shared memory.

FIG. 2 is a block diagram of an example implementation of the distributed heap manager circuitry of FIG. 1.

FIG. 3 is a block diagram of an example environment of the shared heap of FIG. 1.

FIG. 4 is a block diagram of an example environment of a queue and an argument frame in the shared heap of FIG. 1.

FIG. 5 is a process diagram of an example shared heap creation.

FIGS. 6-7 are flowcharts representative of example machine readable instructions and/or example operations that may be executed, instantiated, and/or performed by example programmable circuitry to implement the distributed heap manager circuitry of FIG. 2.

FIG. 8 is a block diagram of an example processing platform including programmable circuitry structured to execute, instantiate, and/or perform the example machine readable instructions and/or perform the example operations of FIGS. 6-7 to implement the distributed heap manager circuitry of FIG. 2.

FIG. 9 is a block diagram of an example implementation of the programmable circuitry of FIG. 8.

FIG. 10 is a block diagram of another example implementation of the programmable circuitry of FIG. 8.

FIG. 11 is a block diagram of an example software/firmware/instructions distribution platform (e.g., one or more servers) to distribute software, instructions, and/or firmware (e.g., corresponding to the example machine readable instructions of FIGS. 6-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

The process of inter-process communication (IPC) involves complex communication mechanisms to invoke and perform a request. As used herein, an IPC is a technique where one process interacts with another process (e.g., a first process interacts with a second process). A process, as used herein, includes a processor and a memory. The processor is a compute resource (e.g., a physical component used to do computational work) that executes instructions to perform work (e.g., a CPU core) and the memory is a compute resource that provides storage for data used by the processor as input and output. In IPC, one thread (e.g., a sequence of instructions to be executed by a processor) of a first process may execute at a time. Then, via an interconnect, the first process communicates the thread to the second process. As used herein, an interconnection is a collection of hardware and/or software used to provide a readable copy of data to be made available across Process Boundaries (e.g., a network fabric, point-to-point connection, etc.). The data of an interconnection is used to instruct the second process of what it should do to execute the thread of the first process. In order for the second process to begin execution, a signal must be sent by the first process to the second process. The signal may be hardware and/or software and alerts the second process that there is data to be consumed (e.g., unlock a mutex, generate an interrupt, etc.).

In an IPC exchange, upon receipt of a request by a first process, a marshaller prepares data for transmission (e.g., marshal the data) to a second process via an interconnect. The marshaller can be a hardware and/or software component. Depending on the method employed for marshalling, marshalling could involve serialization. Serialization copies argument data into a contiguous byte stream suitable for transmission over the interconnect. Marshalling is an expensive task for the system. In some examples, such as with nested structures, simple serialization is not enough. For nested structures, local references must be translated to be valid in the second process. Therefore, marshallers use specific knowledge of the structure of the argument data being moved. Relying on such specific knowledge results in a large expense to the system to undertake marshalling.

Further, after marshalling, the desired data is made visible to the second process using the interconnect. Typically, making the data visible to the second process involves two steps. First, the marshalled data is sent to the second process side of the interconnect. Sending the data may involve further copying of the serialized data to device driver buffers followed by physical transmission over a network fabric via a hardware device (e.g., a network interface). Second, the marshalled data must be received by the second process.

After receipt of the marshalled data by the second process, the first process sends a signal to the second process indicating that there is data available. The signal may be implemented via software (e.g., an atomic location in shared heap memory that is polled) or via hardware such as a register (e.g., a CXL.io register, where CXL is a Compute Express Link® (CXL®) cache-coherent interconnect for processors).

After the signal has been received by the second process, the second process routes the message to execute the thread. Before execution, an unmarshaller prepares previously marshalled data by the first process for use by the second process. Like the marshal step, unmarshalling can be a complex operation depending on the intricacies of the data.

The process described above may implement a procedure call where a thread of execution (e.g., a caller, a requestor, a client, the first process, etc.) causes another thread of execution (e.g., a procedure, a receiver, a server, the second process, etc.) to begin. Data arguments are passed by value from the caller to the procedure. The above relationship may describe a remote procedure call (RPC) where, in a client/server relationship, a client process uses the IPC framework to request work to be performed on a server process. The result data may be returned by value to the caller.

The passing of data by value is an expensive, time-consuming process. For data to be passed by value, the data is copied from memory of the first process to memory of the second process. For this transmission to occur, marshalling and transmission of data are performed, as described above. Marshalling and transmission of data by value greatly increases the procedural costs of IPCs.

For example, the total latency time it takes to send an IPC includes the time to marshal the data, send the data, receive the data, signal the second process, unmarshall the data, perform the request, and return the result. The latency can result in a substantial lag in executing an IPC/RPC Process and loss of efficiency.

Further, application data is often structured so that the data objects reference other data objects by embedding a reference to the object's location in the data set. These references (e.g., pointers) are specific to the physical data layout in the process memory. The process of marshalling embedded references in data sets is involved. Instead of simply copying the binary values of the data set, the data must be serialized by copying the data into a contiguous buffer for transmission to the second process. Therefore, a serializer has to “walk” the various data structures by following the pointers to ensure the completion of a coherent copy. This process requires the serializer to have an intimate understanding of the data object's internal structures.

When the data arrives to the second process, the data is unmarshalled by copying the data into a working set. The working set (e.g., a buffer) on the second process begins at the start of the data set. However, due to the marshalling process, even if the object placement in memory is the same, the embedded pointers are incorrect as they point to addresses that were accurate in the first process. The second process must unmarshall the data so that any pointers now point to the proper local address relative to an address space of the second process.

In some examples, important data is “cherry-picked” from the first process, and only that data is sent to the second process.

When using a transport mechanism that copies argument data, the argument data is passed by value. Passing by value introduces the need for marshalling and/or unmarshalling and the associated costs of data transmission. Therefore, the applicability of IPC-based solutions has historically been limited. Examples disclosed herein substantially reduce or eliminate IPC marshalling and unmarshalling and the efficiency losses in transmission of data by value through use of a shared heap between processes.

Implementation of a shared heap with a common virtual address mapping technique to hold argument data substantially reduces or eliminates the marshalling and unmarshalling costs of IPC. Transmission costs are dramatically reduced by using shared memory as an interconnect. Distributed shared memory solutions (e.g., a CXL.mem type 3 device) enables IPC across multiple nodes. As disclosed herein, a shared memory approach is implemented for an efficient IPC framework so that inter-process communication across several nodes (e.g., an RPC) may be accomplished without marshalling.

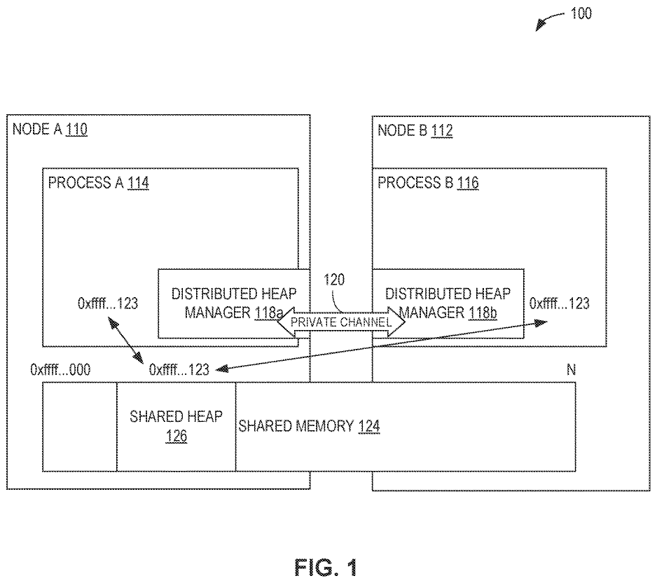

FIG. 1 is a block diagram of an example environment 100 in including an example shared memory 124 accessible by multiple processes. The example environment 100 includes two nodes: example Node A 110 and example Node B 112. Node A 110 includes example Process A 114 (e.g., a first process), and Node B 112 includes example Process B 116 (e.g., a second process). Node A 110 and Node B 112 include respective example distributed heap managers 118a,b. The distributed heap managers 118a,b are substantially similar or identical to one another. Although two nodes 110, 112 are shown with respective processes 114, 116, examples disclosed herein may be implemented with multiple processes (e.g., the processes 114, 116) executing on a single node.

In the example of FIG. 1, Node A 110 and Node B 112 share an example shared memory 124. The shared memory 124 includes a shared heap 126 that is accessible by Process A 114 and Process B 116. The shared memory 124 is a size of 0xffff . . . 000 to N. The shared heap 126 is accessible at a virtual address of 0xffff . . . 123 by both Process A 114 and Process B 116. That is, the virtual address of 0xffff . . . 123 is native to both Process A 114 and Process B 116 so that both processes can access the shared heap 126 by using the same virtual address 0xffff . . . 123.

As used herein, virtual addresses are memory addresses that are local or native to a node or process in that the node or process uses a virtual address to reference a memory location having a different physical address in a memory device. For example, a memory device (e.g., the shared memory 124) may have a physical address range 0x0000h (e.g., h=hexadecimal) to 0xFFFFh for a 64-kilobyte memory device. However, a node or process may map the physical addresses of this memory device to a virtual address range of 0x0001 0000h to 0x0001 FFFFh in a physical-to-virtual address map. As such, when the node or process requests access to virtual memory address 0x0001 0000h, a memory management unit (MMU) uses the physical-to-virtual address map to translate this to the correct physical address of 0x0000 0000h of the corresponding 64-kilobyte memory device.

The distributed heap manager 118a,b is a hardware and/or software component that performs allocation and mapping of memory spaces in the shared memory 124 (e.g., the shared heap 126) between Process A 114 and Process B 116. Although two nodes 110, 112 are shown in FIG. 1, examples disclosed herein may be implemented across more than two nodes to allocate a shared heap between those multiple nodes. Further, examples disclosed herein may be implemented on one node executing multiple processes to allocate a shared heap between those multiple processes in the same node. As such, distributed heap managers like the distributed heap managers 118a,b may be provided in multiple processes across several nodes or in multiple processes in the same node. The distributed heap manager 118a,b uses system software and hardware to allocate and map shared memory resources into a process memory address space. Therefore, the distributed heap manager 118a,b enables processes to access a shared heap (e.g., the shared heap 126) in a shared memory (e.g., the shared memory 124) using the same native virtual address. The distributed heap manager 118a,b also implements a method to map physical memory into specified virtual address ranges. An example compatible multi-node configuration may include: two processes (e.g., Process A 114 and Process B 116) executing on respective x86-compatible processors or any other suitable processors. Each node (e.g., Node A 110 and Node B 112) may execute a Linux operating system including a CXL type 3 memory device exposed to both nodes via CXL.mem.

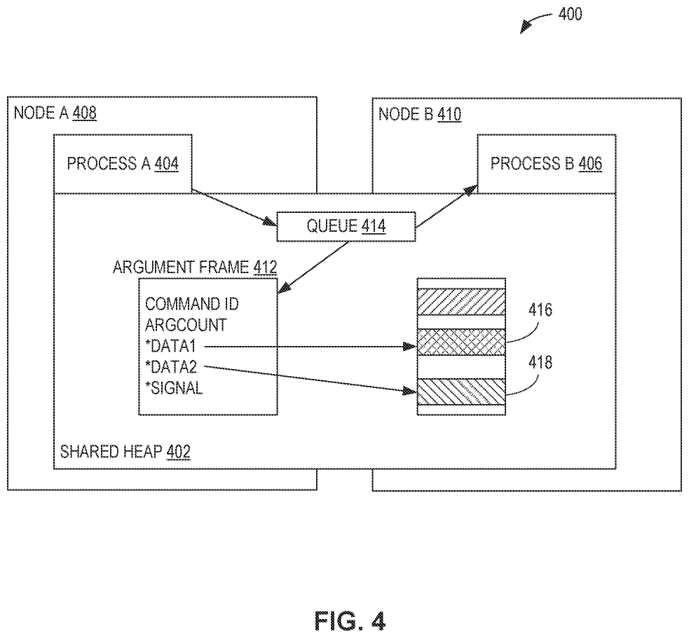

The shared heap 126 is a memory resource, managed by the distributed heap manager 118a,b, and is shared between two or more processes (e.g., Process A 114 and Process B 116, the first process and the second process, etc.). In the example of FIG. 1, Process A 114 and Process B 116 share the same memory resource and data. The distributed heap manager 118a,b is responsible for mapping the physical shared memory resource into the same address range on all participating processes (e.g., Process A 114 and Process B 116, the first process and the second process, etc.). Therefore, a data value accessible at a virtual memory address location in the shared heap 126 in one process will be the same value accessible by a different process at that same virtual memory address location. By passing arguments via the shared heap 126 as described in detail below in connection with FIG. 4, the data does not move. Because the shared heap 126 is mapped identically to Process A 114 and Process B 116, all references (e.g., pointers, etc.) remain valid as long as they point to somewhere within the shared heap 126. Therefore, this eliminates the need for marshalling/unmarshalling.

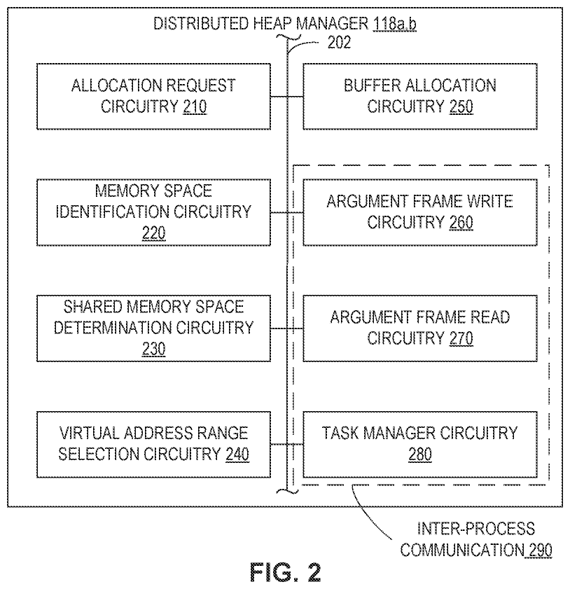

FIG. 2 is a block diagram of an example implementation of the distributed heap manager 118a,b (e.g., distributed heap manager circuitry) of FIG. 1 to facilitate inter-process communication. The distributed heap manager 118a,b of FIG. 2 may be instantiated (e.g., creating an instance of, bring into being for any length of time, materialize, implement, etc.) by programmable circuitry such as a Central Processor Unit (CPU) executing first instructions. Additionally or alternatively, the distributed heap manager 118a,b of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The distributed heap manager 118a,b includes example allocation request circuitry 210, example memory space identification circuitry 220, example shared memory space determination circuitry 230, example virtual address translation circuitry 240, example buffer allocation circuitry 250, example argument frame write circuitry 260, example argument frame read circuitry 270, and example task manager circuitry 280. Further, the allocation request circuitry 210, the memory space identification circuitry 220, the shared memory space determination circuitry 230, the virtual address translation circuitry 240, the buffer allocation circuitry 250, the argument frame write circuitry 260, the argument frame read circuitry 270, and the task manager circuitry 280 are connected by an example bus 202.

The distributed heap manager 118a of Node A 114 in FIG. 1 is substantially similar or identical to the distributed heap manger 118b in Node B 116. As such, descriptions below for any particular component of the distributed heap manager 118a,b apply to implementations of the distributed manager 118a,b in any node. In addition, because the distributed heap managers 118a,b participate at respective sides of a shared heap allocation process, descriptions of some components of the distributed heap manager 118a,b apply to operations of one node (e.g., the distributed heap manager 118a at Node A 110) that initiates a request to allocate shared heap memory space and descriptions of other components of the distributed heap manager 118a,b apply to operations of another node (e.g., the distributed heap manager 118b at Node B 112) that receives a request to allocate shared heap memory space. When roles change between nodes from allocation request sender to allocation request receiver, the descriptions below apply equally to either distributed heap manager 118a,b depending on its role in the heap allocation process.

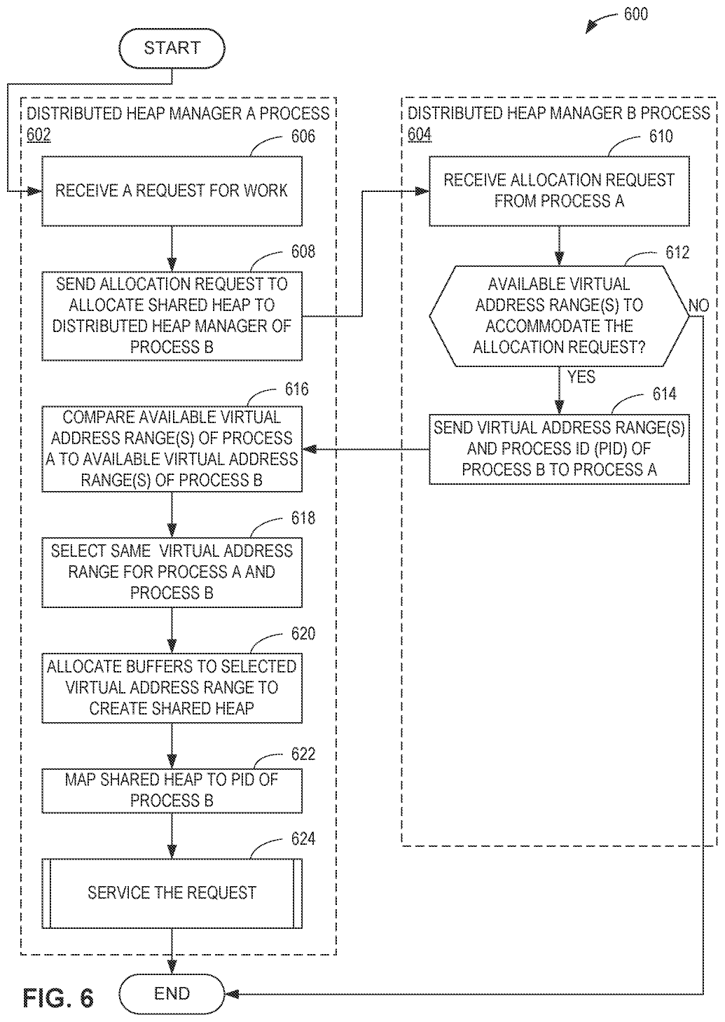

The allocation request circuitry 210 is provided to send requests for shared heap allocation. For example, from the perspective of the distributed heap manager 118a of Node A 110, the allocation request circuitry 210 can send a shared heap allocation request from Process A 114 (FIG. 1) to the distributed heap manager 118b corresponding to Process B 116 (FIG. 1). The shared heap allocation request is a request to allocate a shared heap (e.g., a request to allocate the shared heap 126 in the shared memory 124). In some examples, the allocation request circuitry 210 is instantiated by programmable circuitry executing allocation request instructions and/or configured to perform operations such as those represented by the flowchart of FIG. 6 (e.g., blocks 606 and 608).

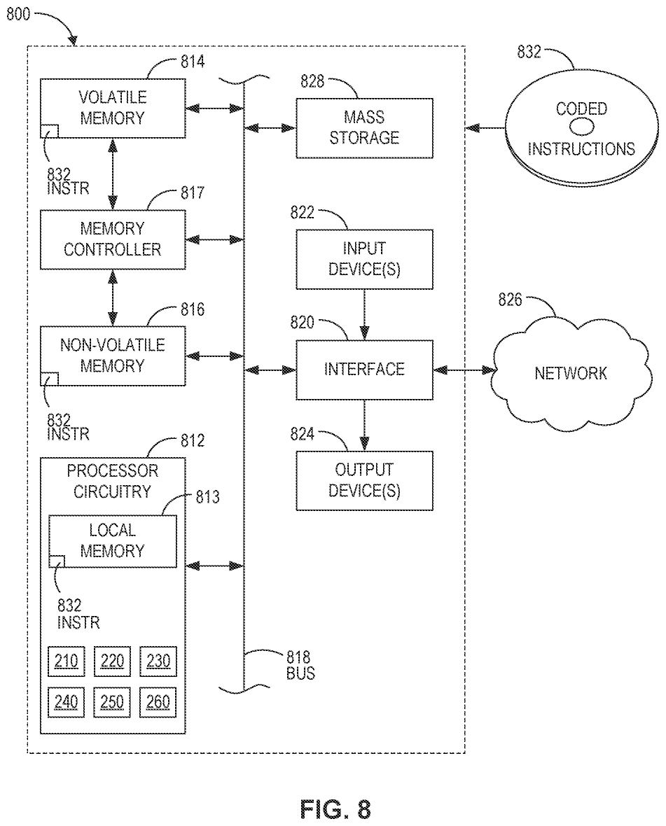

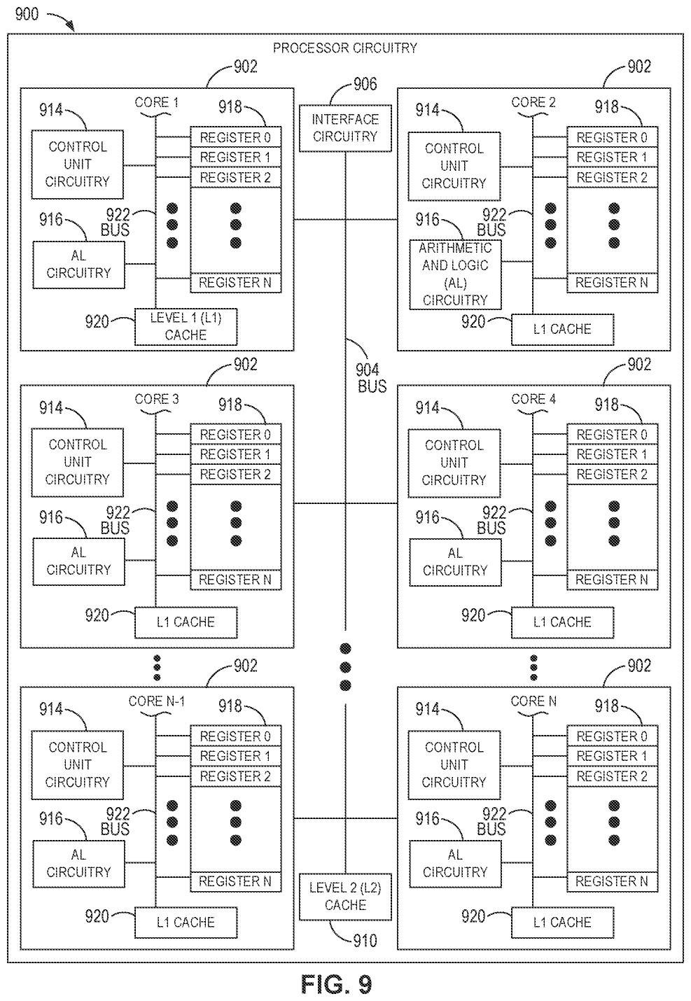

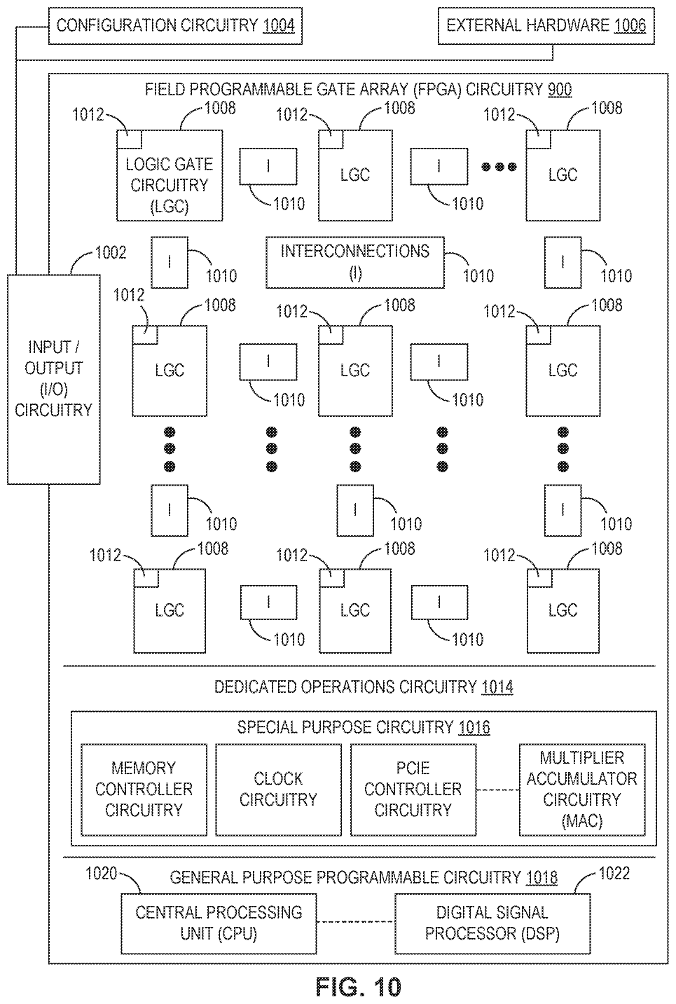

In some examples, the distributed heap manager 118a,b includes means for requesting an allocation. For example, the means for requesting an allocation may be implemented by the allocation request circuitry 210. In some examples, the allocation request circuitry 210 may be instantiated by programmable circuitry such as the example programmable circuitry 812 of FIG. 8. For instance, the allocation request circuitry 210 may be instantiated by the example microprocessor 900 of FIG. 9 executing machine executable instructions such as those implemented by at least blocks 606, 608 of FIG. 6. In some examples, the allocation request circuitry 210 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the allocation request circuitry 210 may be instantiated by any other combination of hardware, software, and/or firmware. For example, the allocation request circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The memory space identification circuitry 220 is provided to identify available virtual address ranges in a local virtual address map (e.g., a local virtual address map of Process A 114 or Process B 116). For example, from the perspective of the distributed heap manager 118b of Node B 112, a shared heap allocation request is received at Process B 116 from Process A 114. The shared heap allocation request causes the memory space identification circuitry 220 of the distributed heap manger 118b to generate a listing of one or more virtual address ranges available in the local virtual address map of Process B 116 in which to create a shared heap. In some examples, Process A 114 specifies a memory space size for the shared heap allocation in the shared heap allocation request provided by the allocation request circuitry 210. In such examples, the memory space identification circuitry 220 searches the local virtual address map of Process B 116 based on the specified memory space size to determine spaces that can accommodate the allocation request. In such examples, the memory space identification circuitry 220 determines spaces of memory available to Process B 116 that can accommodate the request (e.g., memory space size, etc.).

The memory space identification circuitry 220 sends the virtual addresses of the identified virtual address range and/or ranges and a process identifier (PID) of Process B 116 to the distributed heap manager 118a of Process A 114. The Process B PID can be subsequently used by Process A 114 in association with data placed in the shared heap 126 so that Process B 116, which is associated with the Process B PID, can access the data in the shared heap 126 provided by Process A 114. In some examples, the memory space identification circuitry 220 is instantiated by programmable circuitry executing memory space identification instructions and/or configured to perform operations such as those represented by the flowchart of FIG. 6 (blocks 610-614).

In some examples, the distributed heap manager 118a,b includes means for identifying a memory space. For example, the means for identifying a memory space may be implemented by the memory space identification circuitry 220. In some examples, the memory space identification circuitry 220 may be instantiated by programmable circuitry such as the example programmable circuitry 812 of FIG. 8. For instance, the memory space identification circuitry 220 may be instantiated by the example microprocessor 900 of FIG. 9 executing machine executable instructions such as those implemented by at least blocks 610-614 of FIG. 6. In some examples, the memory space identification circuitry 220 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the memory space identification circuitry 220 may be instantiated by any other combination of hardware, software, and/or firmware. For example, the memory space identification circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

Returning to the perspective of the distributed heap manager 118a of Node A 110, the shared memory space determination circuitry 230 receives the listing of virtual address range(s) and the Process B PID of Process B 116. The shared memory space determination circuitry 230 compares the listing of available virtual address range(s) from Process B 116 to available local virtual address ranges of Process A 116 to determine whether there are available virtual address ranges overlapping between Process A 114 and Process B 116 to accommodate the shared heap allocation request. In some examples, the shared memory space determination circuitry 230 compares the first virtual address range(s) of Process A 114 with the second virtual address range(s) of Process B 116. In some examples, the shared memory space determination circuitry 230 is instantiated by programmable circuitry executing shared memory space determination instructions and/or configured to perform operations such as those represented by the flowchart of FIG. 6 (block 616).

In some examples, the distributed heap manager 118a,b includes means for determining shared memory spaces. For example, the means for determining shared memory spaces may be implemented by the shared memory space determination circuitry 230. In some examples, the shared memory space determination circuitry 230 may be instantiated by programmable circuitry such as the example programmable circuitry 812 of FIG. 8. For instance, the shared memory space determination circuitry 230 may be instantiated by the example microprocessor 900 of FIG. 9 executing machine executable instructions such as those implemented by at least block 616 of FIG. 6. In some examples, the shared memory space determination circuitry 230 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the shared memory space determination circuitry 230 may be instantiated by any other combination of hardware, software, and/or firmware. For example, the shared memory space determination circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The virtual address range selection circuitry 240 is provided to select an overlapping or same virtual address range available in both Process A 114 and Process B 116. For example, the virtual address range selection circuitry 240 selects a virtual address range in the shared memory 124 that corresponds to a first virtual address range of Process A 114 and a second virtual address range of Process B 116. Therefore, the virtual address range selection circuitry 240 determines in which address range the shared heap 126 can be allocated. In some examples, the virtual address range selection circuitry 240 is instantiated by programmable circuitry executing virtual address range selection instructions and/or configured to perform operations such as those represented by the flowchart of FIG. 6 (block 618).

In some examples, the distributed heap manager 118a,b includes means for selecting a virtual address range. For example, the means for selecting a virtual address range may be implemented by the virtual address range selection circuitry 240. In some examples, the virtual address range selection circuitry 240 may be instantiated by programmable circuitry such as the example programmable circuitry 812 of FIG. 8. For instance, the virtual address range selection circuitry 240 may be instantiated by the example microprocessor 900 of FIG. 9 executing machine executable instructions such as those implemented by at least block 618 of FIG. 6. In some examples, the virtual address range selection circuitry 240 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the virtual address range selection circuitry 240 may be instantiated by any other combination of hardware, software, and/or firmware. For example, the virtual address range selection circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The buffer allocation circuitry 250 is provided to allocate buffers in the selected virtual address range to create the shared heap 126. For example, the buffer allocation circuitry 250 of the distributed heap manager 118a at Node A 110 allocates buffers in the selected virtual address range for access by Process A 114. The buffer allocation circuitry 250 also generates a notification to notify the buffer allocation circuitry 250 of the distributed heap manager 118b at Node B 112 to allocate buffers in the selected virtual address range for access by Process B 116. At Node A 110, the buffer allocation circuitry 250 maps the shared heap 126 to the Process B PID of Process B 116 so that Process B 116 may access the shared heap 126. In some examples, the buffer allocation circuitry 250 is instantiated by programmable circuitry executing buffer allocation instructions and/or configured to perform operations such as those represented by the flowchart of FIG. 6 (blocks 620, 622).

In some examples, the distributed heap manager 118a,b includes means for allocating buffers to the selected virtual address range. For example, the means for allocating buffers may be implemented by the buffer allocation circuitry 250. In some examples, the buffer allocation circuitry 250 may be instantiated by programmable circuitry such as the example programmable circuitry 812 of FIG. 8. For instance, the buffer allocation circuitry 250 may be instantiated by the example microprocessor 900 of FIG. 9 executing machine executable instructions such as those implemented by at least blocks 620, 622 of FIG. 6. In some examples, the buffer allocation circuitry 250 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the buffer allocation circuitry 250 may be instantiated by any other combination of hardware, software, and/or firmware. For example, the buffer allocation circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example argument frame write circuitry 260, the example argument frame read circuitry 270, and the example task manager circuitry 280 instantiate an example inter-process communication 290. The inter-process communication 290 occurs after buffers are allocated by the buffer allocation circuitry 250 to create the shared heap (e.g., the shared heap 126 of FIG. 1).

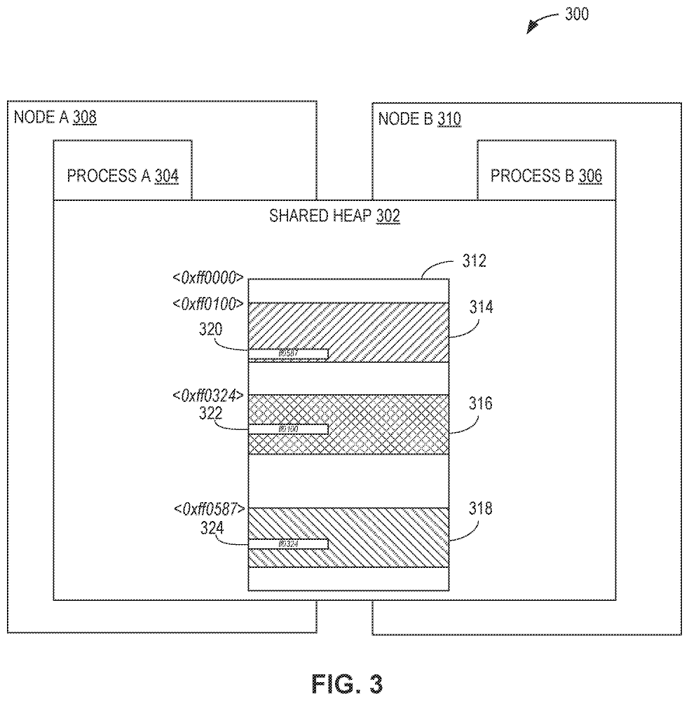

The argument frame write circuitry 260 is provided to write data or an address to the data in an argument frame (e.g., the argument frame 312 of FIG. 3, the argument frame 412 of FIG. 4) in the shared heap 126. For example, from the perspective of the distributed heap manager 118a of Node A 110, the argument frame write circuitry 260 writes the data or an address to the data in the argument frame so that Process B 116 can access the data in the shared heap 126. For example, Process A 114 may request that Process B 116 perform an operation on the data and return a result.

For examples in which the argument frame write circuitry 260 of Node A 110 writes the data in the argument frame (e.g., passing data by value), Process B 116 accesses the data directly in the argument frame. For examples in which the argument frame write circuitry 260 writes an address in the argument frame (e.g., passing data by reference) that points to a shared memory location at which data for Process B 116 is located, such memory location can be in the same shared heap 126 or in any other shared heap allocated (e.g., using techniques disclosed herein) for access by both Process A 114 and Process B 116. As described in further detail below in connection to FIG. 4, an argument frame is a structured set of data residing in the shared heap 126 and is used to pass arguments in an IPC.

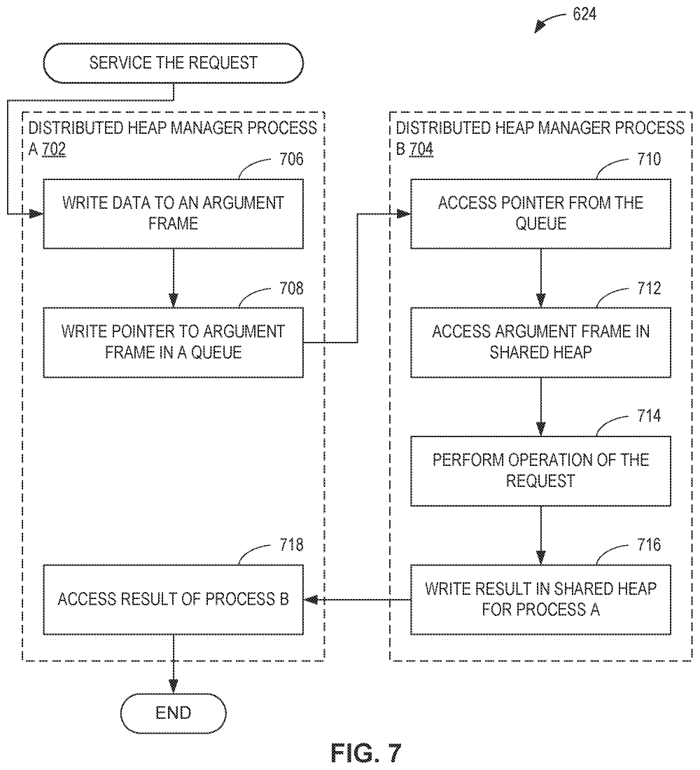

The argument frame write circuitry 260 writes a pointer (e.g., a reference to data, an address location, a reference address, etc.) to the argument frame in a queue (e.g., the queue 414 of FIG. 4). The queue, as described in further detail below in connection to FIG. 4, is an interconnect between in the shared heap 126 between processes (e.g., between Process A 114 and Process B 116). In some examples, the argument frame write circuitry 260 is instantiated by programmable circuitry executing argument frame write instructions and/or configured to perform operations such as those represented by the flowchart of FIG. 7 (blocks 706 and 708).

In some examples, the distributed heap manager 118a,b includes means for writing data to an argument frame. For example, the means for writing may be implemented by the argument frame write circuitry 260. In some examples, the argument frame write circuitry 260 may be instantiated by programmable circuitry such as the example programmable circuitry 812 of FIG. 8. For instance, the argument frame write circuitry 260 may be instantiated by the example microprocessor 900 of FIG. 9 executing machine executable instructions such as those implemented by at least blocks 706, 708 of FIG. 7. In some examples, the argument frame write circuitry 260 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the argument frame write circuitry 260 may be instantiated by any other combination of hardware, software, and/or firmware. For example, the argument frame write circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The argument frame read circuitry 270 is provided to access the pointer from the queue and access the argument frame in the shared heap 126 based on the pointer. For example, from the perspective of the distributed heap manager 118b of Node B 112, the argument frame read circuitry 270 accesses data based on the argument frame from Process A 114. For example, the argument frame read circuitry 270 accesses data in the argument frame (e.g., data passed by value) or data at a memory location corresponding to an address in the argument frame (e.g., data passed by reference). In some examples, the argument frame read circuitry 270 is instantiated by programmable circuitry executing argument frame read instructions and/or configured to perform operations such as those represented by the flowchart of FIG. 7 (blocks 710, 712).

In some examples, the distributed heap manager 118a,b includes means for reading data from an argument frame. For example, the means for reading data may be implemented by the argument frame read circuitry 270. In some examples, the argument frame read circuitry 270 may be instantiated by programmable circuitry such as the example programmable circuitry 812 of FIG. 8. For instance, the argument frame read circuitry 270 may be instantiated by the example microprocessor 900 of FIG. 9 executing machine executable instructions such as those implemented by at least blocks 710, 712 of FIG. 7. In some examples, the argument frame read circuitry 270 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the argument frame read circuitry 270 may be instantiated by any other combination of hardware, software, and/or firmware. For example, the argument frame read circuitry 270 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The task manager circuitry 280 is provided to create and manage tasks to perform requested operations on data obtained using an argument frame. For example, if the data is provided from Process A 114 to

Process B 116, the task manager circuitry 280 of the distributed heap manager 118b of Node B 112 creates a task to perform an operation requested by Process A 114 and manages the execution of that task by Process B 116. For example, the task manager circuitry 280 may add the task to a work queue of Process B 116. The argument frame write circuitry 260 writes a result produced by the performance of the operation or task in the shared heap 126. In this manner, the argument frame read circuitry 270 associated with Process A 114 can access the result in the shared heap 126. In some examples, the task manager circuitry 280 is instantiated by programmable circuitry executing task manager instructions and/or configured to perform operations such as those represented by the flowchart of FIG. 7 (block 714).

In some examples, the distributed heap manager 118a,b includes means for managing the operation of the request. For example, the means for managing may be implemented by the task manager circuitry 280. In some examples, the task manager circuitry 280 may be instantiated by programmable circuitry such as the example programmable circuitry 812 of FIG. 8. For instance, the task manager circuitry 280 may be instantiated by the example microprocessor 900 of FIG. 9 executing machine executable instructions such as those implemented by at least block 714 of FIG. 7. In some examples, the task manager circuitry 280 may be instantiated by hardware logic circuitry, which may be implemented by an ASIC, XPU, or the FPGA circuitry 1000 of FIG. 10 configured and/or structured to perform operations corresponding to the machine readable instructions. Additionally or alternatively, the task manager circuitry 280 may be instantiated by any other combination of hardware, software, and/or firmware. For example, the task manager circuitry 280 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate. While an example manner of implementing the distributed heap manager 118a,b of FIG. 1 is illustrated in FIG. 2, one or more of the elements, processes, and/or devices illustrated in FIG. 2 may be combined, divided, re-arranged, omitted, eliminated, and/or implemented in any other way. Further, the allocation request circuitry 210, the memory space identification circuitry 220, the shared memory space determination circuitry 230, the virtual address range selection circuitry 240, the buffer allocation circuitry 250, the argument frame write circuitry 260, the argument frame read circuitry 270, the task manager circuitry 280, and/or, more generally, the example distributed heap manager 118a,b of FIG. 2, may be implemented by hardware alone or by hardware in combination with software and/or firmware. Thus, for example, any of the allocation request circuitry 210, the memory space identification circuitry 220, the shared memory space determination circuitry 230, the virtual address range selection circuitry 240, the buffer allocation circuitry 250, the argument frame write circuitry 260, the argument frame read circuitry 270, the task manager circuitry 280, and/or, more generally, the example distributed heap manager 118a,b, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example distributed heap manager 118a,b of FIG. 2 may include one or more elements, processes, and/or devices in addition to, or instead of, those illustrated in FIG. 2, and/or may include more than one of any or all of the illustrated elements, processes and devices.

FIG. 3 is an example environment 300 including an example shared heap 302 of an example Process A 304 and an example Process B 306. The shared heap 302 is implemented similar to how the shared heap 126 of FIG. 1 is implemented. Like the environment 100 of FIG. 1, an example Node A 308 executes Process A 304 and an example Node B 310 executes Process B 306. The shared heap 302 includes an example argument frame 312. The argument frame 312 is a structured set of data that is accessible by (e.g., shared) both Process A 304 and Process B 306. Although only two processes are shown, the shared heap 302 may be accessible by more than two processes in any number of nodes (e.g., the shared heap 302 may be accessed by a third process and/or to any number of processes involved in IPC). The structure of the argument frame 312 is implementation specific. Further, argument values that are passed in the argument frame 312 may be sent either by value or by reference. When data is passed by value, that means that the data itself is passed in the argument frame 312. In the illustrated example of FIG. 3, data 314, 316, 318 is passed by value via the argument frame 312. Transmission of the data 314, 316, 318 by value is efficient through usage of the argument frame 312 due to the shared accessibility of the shared heap 302. Process B 306 accesses the data 314, 316, 318 of Process A 304 via the argument frame 312 where embedded references 320, 322, 324 refer to the same portions (e.g., virtual address locations) of memory shared by Process A 304 and Process B 306. Therefore, Process B 306 can access the data 314, 316, 318 at the same virtual addresses 0xff0100, 0xff0324, 0xff0587, respectively.

FIG. 4 is an example environment 400 including an example shared heap 402 of an example Process A 404 and an example Process B 406. Process A 404 allocates the shared heap 402 with Process B 406 via a distributed heap manager (e.g., the distributed heap manager 118a of Process A 114 of FIG. 1). The shared heap 402 is implemented similar to how the shared heap 126 of FIG. 1 is implemented. Like the environment 100 of FIG. 1, an example Node A 408 executes Process A 404 and an example Node B 410 executes Process B 406. The shared heap 402 includes an example argument frame 412. In this example, data is passed by reference via the argument frame 412. For example, when data is passed by reference, a distributed heap manager (e.g., the distributed heap manager 118a) associated with Process A 404 writes a pointer corresponding to a memory location in the argument frame 412. Then, a distributed heap manager (e.g., the distributed heap manager 118b) associated with Process B 410 may read the pointer and access the data referenced at some location in the shared heap 402. As shown, in this example, *DATA1 represents a pointer to first data (e.g., DATA1) at memory location 416 and *DATA2 represents a pointer to second data (e.g., DATA2) at memory location 418.

To invoke an IPC, Process A 404 writes to the argument frame 412 data to be “sent.” Then, Process A 404 writes a message in the queue 414 that includes a memory address at which the argument frame 412 is located in the shared heap 402. Process B 406 accesses the message in the queue 414, obtains the memory address of the argument frame 412, and accesses the argument frame 412 to obtain the data passed by Process A 404.

The queue 414 is an allocated portion of the shared heap 402 and may be instantiated by any suitable interconnect implementation. The queue 414 may be instantiated via a shared memory message channel (SMMC). The SMMC is a portion of the shared memory (e.g., the shared memory 124 of FIG. 1) that is used as a high-performance interconnect. The SMMC may be implemented in any suitable manner (e.g., a mailbox, a ring buffer, a vector, etc.). The queue 414 is a single atomic shared memory location used to pass a single message at a time. In such examples, there is an allocated location in the shared heap 402 used to send messages (e.g., the queue 414). Process A 404 waits for the queue 414 to be null indicating availability to send a message (e.g., a reference to an argument frame). Process A 404 writes a message into the queue 414 that includes writing a pointer (e.g., a virtual memory address) in the queue 414 that indicates a memory location of the argument frame 412. In some examples, Process B 406 polls the queue 414 to determine when the queue 414 includes a message to be retrieved. The signaling (e.g., a control message and/or messages) used to determine the state of a queue 414 may be implemented by software and/or hardware (e.g., a reference may be sent via *SIGNAL in the argument frame, a control message, etc.). After Process B 406 reads the queue 414, Process B 406 can clear the queue 414 to allow another pointer to be sent (e.g., Process B 406 can send another signal to signal Process A 404 to send another pointer).

In some examples, the queue 414 may be implemented as a mailbox (e.g., a one-item queue). In some examples, the queue 414 can be implemented by one deep ring buffer. A ring buffer is an array of atomic shared memory locations configured as a circular buffer. In a ring buffer, the argument frame pointers are queued in the shared memory. In some examples, the queue 414 can be a vector. A vector is an array of atomic shared memory locations. The ordinal of the array corresponds to the command/message ID. A single field specifies the vector(s) that are available for processing (e.g., similar to a Vtable in C programming language). In some examples, the queue 414 is instantiated via a transmission control protocol (TCP).

Because Process B 406 accesses the argument frame 412 in the same location as Process A 404, sending a single reference via the queue 414 is sufficient to enable conveying data between processes via the argument frame 412. In addition, when data resides in in shared heaps (e.g., the shared heap 402 or any number of shared heaps accessible by both processes 404, 406), arguments can be passed by reference to substantially reduce or eliminate the need for marshalling and/or unmarshalling. Further, latency times are greatly reduced and/or eliminated because the data is not moved. By passing a pointer in an argument frame, the size of the argument frame to convey the data is greatly reduced since the pointer is merely a memory address of a shared memory location at which the data is located in a shared heap.

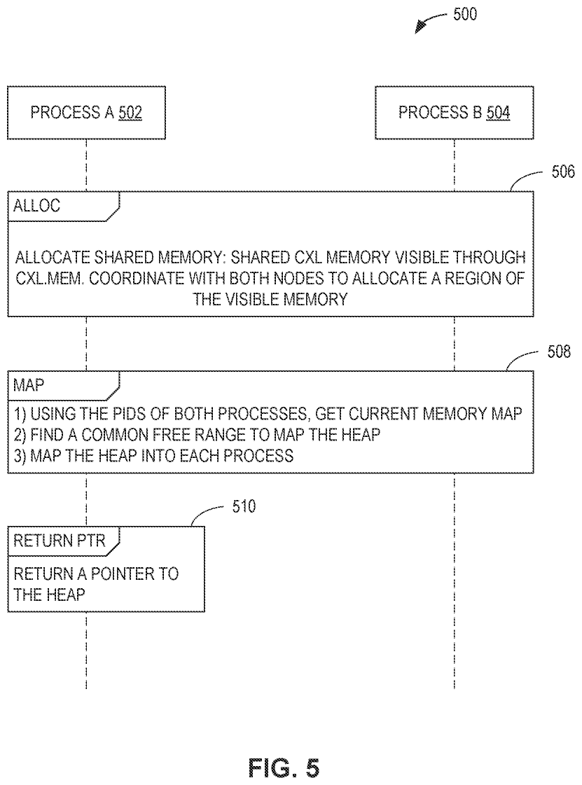

FIG. 5 is an example process flow 500 for a distributed heap manager (e.g., the distributed heap manager 118 of FIG. 1). In this example, Process A 502 (e.g., a first process) requests that a shared heap of size N be allocated (block 506). Therefore, the distributed heap manager of Process A 502 uses the private channel 120 of FIG. 1 (e.g., an interconnect, or any other suitable interconnect IPC mechanism) to communicate with the distributed heap manager of Process B 504 (e.g., the second process). The distributed heap manager of Process B 504 coordinates the allocation of the shared memory (e.g., shared CXL memory) resource. In some examples, the distributed heap manager of Process B 504 coordinates the allocation of the shared CXL memory resources using system kernel drivers, as needed. In some examples, allocation of a region of visible memory (e.g., shared memory) is done by creating direct access (e.g., dax) devices on nodes of the respective processes 502, 504. The direct access devices point to the same physical memory.

At block 508, Process A 502 passes a PID of Process B 504 to the distributed heap manager of Process A 502 so that Process B 504 can participate in the shared heap. Therefore, Process A 502 passes a PID that can be resolved to Process B 504. Process A 502 has access to a current memory map of both Process A 502 and Process B 504. Process A 502 finds a common free range to map the shared heap. After the common free range is selected, the shared heap is mapped into each process (e.g., via an mmap).

At block 510, a pointer to the shared heap is returned. For example, Process A 502 returns the pointer to the shared heap to Process B 504 via the private channel 120 (e.g., an interconnect, or any other suitable interconnect IPC mechanism). To create the pointer, Process A 502 uses a distributed heap manager to allocate smaller buffers to create the shared heap at a memory range in shared memory. Because the shared heap is mapped to the same virtual memory address range on Process A 502 and on Process B 504, any pointer to the shared heap allocated on Process A 502 is valid on Process B 504. In some examples, more than one process may share a distribution heap (e.g., a third process, a fourth process, etc.).

Flowcharts representative of example machine readable instructions, which may be executed by programmable circuitry to implement and/or instantiate the distributed heap manager 118a,b of FIG. 2 and/or representative of example operations which may be performed by programmable circuitry to implement and/or instantiate the distributed heap manager 118a,b of FIG. 2, are shown in FIGS. 6-7. The machine readable instructions may be one or more executable programs or portion(s) of one or more executable programs for execution by programmable circuitry such as the programmable circuitry 812 shown in the example processor platform 800 discussed below in connection with FIG. 8 and/or may be one or more function(s) or portion(s) of functions to be performed by the example programmable circuitry (e.g., an FPGA) discussed below in connection with FIGS. 9 and/or 10. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 6-7, many other methods of implementing the example distributed heap manager 118a,b may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 6-7 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 6 is a flowchart representative of example machine readable instructions and/or example operations 600 that may be executed, instantiated, and/or performed by programmable circuitry to create a shared heap. The instructions and/or operations 600 are shown in connection with an example distributed heap manager A process 602 and an example distributed heap manager B process 604. The distributed heap manager A process 602 may be implemented by a first distributed heap manager, such as the distributed heap manager 118a of FIG. 1 corresponding to a first process (e.g., Process A 114 of FIG. 1, Process A 304 of FIG. 3, Process A 404 of FIG. 4). The distributed heap manager B process 604 may be implemented by a second distributed heap manager, such as the distributed heap manager 118b of FIG. 1 corresponding to a second process (e.g., Process B 116 of FIG. 1, Process B 306 of FIG. 3, Process B 406 of FIG. 4).

The example machine-readable instructions and/or the example operations 600 of FIG. 6 begin in the distributed heap manager A process 602 at block 606, at which the allocation request circuitry 210 of distributed heap manager A receives a request for work to be performed. At block 608, the allocation request circuitry 210 of distributed heap manager A sends an allocation request to allocate a shared heap to distributed heap manager B of the second process. For example, the allocated shared heap is to be shared between the first process and the second process.

In the distributed heap manager B process 604 of distributed heap manager B, the memory space identification circuitry 220 receives an allocation request from the first process at block 610. The memory space identification circuitry 220 determines available virtual address range(s) to accommodate the allocation request (e.g., a range of a size to satisfy the request, etc.). If there is not an available virtual address range (block 612: NO), the instructions and/or operations 600 end. If there is an available virtual address range (block 612: YES) (e.g., a second virtual address range), control proceeds to block 614. At block 614, the memory space identification circuitry 220 sends the available virtual address range(s) (e.g., the second virtual address range(s)) and a process identifier (PID) of the first process to the second process.

At block 616, the shared memory space determination circuitry 230 of distributed heap manager A compares the available virtual address range(s) (e.g., the first virtual address range(s)) of the first process to the available virtual address range(s) of the second process. At block 618, the virtual address range selection circuitry 240 of distributed heap manager A selects the same virtual address range for the first and second processes. In some examples, the virtual address range selection circuitry 240 selects a first virtual address range of the first process that matches an available second virtual address range of the second process. The buffer allocation circuitry 250 of distributed heap manager A allocates buffers to the selected virtual address range to create the shared heap at block 620. At block 622, the buffer allocation circuitry 250 maps the shared heap to the PID of the second process so that the second process may access the shared heap. The request is serviced at block 624. Example instructions and/or operations to manage the servicing of the request are described below in connection with FIG. 7. The instructions and/or operations 600 end.

FIG. 7 is a flowchart representative of example machine readable instructions and/or example operations 624 that may be executed, instantiated, and/or performed by programmable circuitry to service a request for work to be performed. The example machine-readable instructions and/or the example operations 624 of FIG. 7 begin at block 706 of distributed heap manager A process 602, at which the argument frame write circuitry 260 of distributed heap manager A writes data to an argument frame. The argument frame write circuitry 260, at block 708, writes a pointer that references the argument frame in a queue 414. Distributed heap manager A signals to distributed heap manager B that a pointer is in the queue 414.

The argument frame read circuitry 270 of distributed heap manager B accesses the pointer from the queue 414 at block 710. At block 712, the argument frame read circuitry 270 accesses the argument frame in the shared heap via the pointer. At block 714, the task manager circuitry 280 of distributed heap manager B queues the operation of the request in a work queue of the second process so that the second process can perform the operation. At block 716, the task manager circuitry 280 writes the result from the second process to the shared heap to send to the first process. Distributed heap manager A accesses the result of the operation performed by the second process at block 718. The instructions and/or operations 624 end and control returns to block 624 of FIG. 6.

FIG. 8 is a block diagram of an example programmable circuitry platform 800 structured to execute and/or instantiate the example machine-readable instructions and/or the example operations of FIGS. 6-7 to implement the distributed heap manager circuitry 118a,b of FIG. 2. The programmable circuitry platform 800 can be, for example, a server, a personal computer, a workstation, a self-learning machine (e.g., a neural network), a mobile device (e.g., a cell phone, a smart phone, a tablet such as an iPad™, an Internet appliance, a gaming console, a headset (e.g., an augmented reality (AR) headset, a virtual reality (VR) headset, etc.) or other wearable device, or any other type of computing and/or electronic device.

The programmable circuitry platform 800 of the illustrated example includes programmable circuitry 812. The programmable circuitry 812 of the illustrated example is hardware. For example, the programmable circuitry 812 can be implemented by one or more integrated circuits, logic circuits, FPGAs, microprocessors, CPUs, GPUs, DSPs, and/or microcontrollers from any desired family or manufacturer. The programmable circuitry 812 may be implemented by one or more semiconductor based (e.g., silicon based) devices. In this example, the programmable circuitry 812 implements the allocation request circuitry 210, the memory space identification circuitry 220, the shared memory space determination circuitry 230, the virtual address range selection circuitry 240, the buffer allocation circuitry 250, the argument frame write circuitry 260, the argument frame read circuitry 270, and the task manager circuitry 280.

The programmable circuitry 812 of the illustrated example includes a local memory 813 (e.g., a cache, registers, etc.). The programmable circuitry 812 of the illustrated example is in communication with main memory 814, 816, which includes a volatile memory 814 and a non-volatile memory 816, by a bus 818. The volatile memory 814 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 816 may be implemented by flash memory and/or any other desired type of memory device. Access to the main memory 814, 816 of the illustrated example is controlled by a memory controller 817. In some examples, the memory controller 817 may be implemented by one or more integrated circuits, logic circuits, microcontrollers from any desired family or manufacturer, or any other type of circuitry to manage the flow of data going to and from the main memory 814, 816.

The programmable circuitry platform 800 of the illustrated example also includes interface circuitry 820. The interface circuitry 820 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 822 are connected to the interface circuitry 820. The input device(s) 822 permit(s) a user (e.g., a human user, a machine user, etc.) to enter data and/or commands into the programmable circuitry 812. The input device(s) 822 can be implemented by, for example, an audio sensor, a microphone, a camera (still or video), a keyboard, a button, a mouse, a touchscreen, a trackpad, a trackball, an isopoint device, and/or a voice recognition system.

One or more output devices 824 are also connected to the interface circuitry 820 of the illustrated example. The output device(s) 824 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 820 of the illustrated example, thus, typically includes a graphics driver card, a graphics driver chip, and/or graphics processor circuitry such as a GPU.

The interface circuitry 820 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 826. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 800 of the illustrated example also includes one or more mass storage discs or devices 828 to store firmware, software, and/or data. Examples of such mass storage discs or devices 828 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 832, which may be implemented by the machine readable instructions of FIGS. 6-7, may be stored in the mass storage device 828, in the volatile memory 814, in the non-volatile memory 816, and/or on at least one non-transitory computer readable storage medium such as a CD or DVD which may be removable.

FIG. 9 is a block diagram of an example implementation of the programmable circuitry 812 of FIG. 8. In this example, the programmable circuitry 812 of FIG. 8 is implemented by a microprocessor 900. For example, the microprocessor 900 may be a general-purpose microprocessor (e.g., general-purpose microprocessor circuitry). The microprocessor 900 executes some or all of the machine-readable instructions of the flowcharts of FIGS. 6-7 to effectively instantiate the circuitry of FIG. 2 as logic circuits to perform operations corresponding to those machine readable instructions. In some such examples, the circuitry of FIG. 2 is instantiated by the hardware circuits of the microprocessor 900 in combination with the machine-readable instructions. For example, the microprocessor 900 may be implemented by multi-core hardware circuitry such as a CPU, a DSP, a GPU, an XPU, etc. Although it may include any number of example cores 902 (e.g., 1 core), the microprocessor 900 of this example is a multi-core semiconductor device including N cores. The cores 902 of the microprocessor 900 may operate independently or may cooperate to execute machine readable instructions. For example, machine code corresponding to a firmware program, an embedded software program, or a software program may be executed by one of the cores 902 or may be executed by multiple ones of the cores 902 at the same or different times. In some examples, the machine code corresponding to the firmware program, the embedded software program, or the software program is split into threads and executed in parallel by two or more of the cores 902. The software program may correspond to a portion or all of the machine readable instructions and/or operations represented by the flowcharts of FIGS. 6-7.

The cores 902 may communicate by a first example bus 904. In some examples, the first bus 904 may be implemented by a communication bus to effectuate communication associated with one(s) of the cores 902. For example, the first bus 904 may be implemented by at least one of an Inter-Integrated Circuit (I2C) bus, a Serial Peripheral Interface (SPI) bus, a PCI bus, or a PCIe bus. Additionally or alternatively, the first bus 904 may be implemented by any other type of computing or electrical bus. The cores 902 may obtain data, instructions, and/or signals from one or more external devices by example interface circuitry 906. The cores 902 may output data, instructions, and/or signals to the one or more external devices by the interface circuitry 906. Although the cores 902 of this example include example local memory 920 (e.g., Level 1 (L1) cache that may be split into an L1 data cache and an L1 instruction cache), the microprocessor 900 also includes example shared memory 910 that may be shared by the cores (e.g., Level 2 (L2 cache)) for high-speed access to data and/or instructions. Data and/or instructions may be transferred (e.g., shared) by writing to and/or reading from the shared memory 910. The local memory 920 of each of the cores 902 and the shared memory 910 may be part of a hierarchy of storage devices including multiple levels of cache memory and the main memory (e.g., the main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 902 may be referred to as a CPU, DSP, GPU, etc., or any other type of hardware circuitry. Each core 902 includes control unit circuitry 914, arithmetic and logic (AL) circuitry (sometimes referred to as an ALU) 916, a plurality of registers 918, the local memory 920, and a second example bus 922. Other structures may be present. For example, each core 902 may include vector unit circuitry, single instruction multiple data (SIMD) unit circuitry, load/store unit (LSU) circuitry, branch/jump unit circuitry, floating-point unit (FPU) circuitry, etc. The control unit circuitry 914 includes semiconductor-based circuits structured to control (e.g., coordinate) data movement within the corresponding core 902. The AL circuitry 916 includes semiconductor-based circuits structured to perform one or more mathematic and/or logic operations on the data within the corresponding core 902. The AL circuitry 916 of some examples performs integer based operations. In other examples, the AL circuitry 916 also performs floating-point operations. In yet other examples, the AL circuitry 916 may include first AL circuitry that performs integer-based operations and second AL circuitry that performs floating-point operations. In some examples, the AL circuitry 916 may be referred to as an Arithmetic Logic Unit (ALU).

The registers 918 are semiconductor-based structures to store data and/or instructions such as results of one or more of the operations performed by the AL circuitry 916 of the corresponding core 902. For example, the registers 918 may include vector register(s), SIMD register(s), general-purpose register(s), flag register(s), segment register(s), machine-specific register(s), instruction pointer register(s), control register(s), debug register(s), memory management register(s), machine check register(s), etc. The registers 918 may be arranged in a bank as shown in FIG. 9. Alternatively, the registers 918 may be organized in any other arrangement, format, or structure, such as by being distributed throughout the core 902 to shorten access time. The second bus 922 may be implemented by at least one of an I2C bus, a SPI bus, a PCI bus, or a PCIe bus.

Each core 902 and/or, more generally, the microprocessor 900 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 900 is a semiconductor device fabricated to include many transistors interconnected to implement the structures described above in one or more integrated circuits (ICs) contained in one or more packages.

The microprocessor 900 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 900, in the same chip package as the microprocessor 900 and/or in one or more separate packages from the microprocessor 900.

FIG. 10 is a block diagram of another example implementation of the programmable circuitry 812 of FIG. 8. In this example, the programmable circuitry 812 is implemented by FPGA circuitry 1000. For example, the FPGA circuitry 1000 may be implemented by an FPGA. The FPGA circuitry 1000 can be used, for example, to perform operations that could otherwise be performed by the example microprocessor 900 of FIG. 9 executing corresponding machine readable instructions. However, once configured, the FPGA circuitry 1000 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 900 of FIG. 9 described above (which is a general purpose device that may be programmed to execute some or all of the machine readable instructions represented by the flowchart(s) of FIGS. 6-7 but whose interconnections and logic circuitry are fixed once fabricated), the FPGA circuitry 1000 of the example of FIG. 10 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 6-7. In particular, the FPGA circuitry 1000 may be thought of as an array of logic gates, interconnections, and switches. The switches can be programmed to change how the logic gates are interconnected by the interconnections, effectively forming one or more dedicated logic circuits (unless and until the FPGA circuitry 1000 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 6-7. As such, the FPGA circuitry 1000 may be configured and/or structured to effectively instantiate some or all of the operations/functions corresponding to the machine readable instructions of the flowchart(s) of FIGS. 6-7 as dedicated logic circuits to perform the operations/functions corresponding to those software instructions in a dedicated manner analogous to an ASIC. Therefore, the FPGA circuitry 1000 may perform the operations/functions corresponding to the some or all of the machine readable instructions of FIGS. 6-7 faster than the general-purpose microprocessor can execute the same.

In the example of FIG. 10, the FPGA circuitry 1000 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1000 of FIG. 10 may access and/or load the binary file to cause the FPGA circuitry 1000 of FIG. 10 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1000 of FIG. 10 to cause configuration and/or structuring of the FPGA circuitry 1000 of FIG. 10, or portion(s) thereof.

The FPGA circuitry 1000 of FIG. 10, includes example input/output (I/O) circuitry 1002 to obtain and/or output data to/from example configuration circuitry 1004 and/or external hardware 1006. For example, the configuration circuitry 1004 may be implemented by interface circuitry that may obtain a binary file, which may be implemented by a bit stream, data, and/or machine-readable instructions, to configure the FPGA circuitry 1000, or portion(s) thereof. In some such examples, the configuration circuitry 1004 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1006 may be implemented by external hardware circuitry. For example, the external hardware 1006 may be implemented by the microprocessor 900 of FIG. 9.

The FPGA circuitry 1000 also includes an array of example logic gate circuitry 1008, a plurality of example configurable interconnections 1010, and example storage circuitry 1012. The logic gate circuitry 1008 and the configurable interconnections 1010 are configurable to instantiate one or more operations/functions that may correspond to at least some of the machine readable instructions of FIGS. 6-7 and/or other desired operations. The logic gate circuitry 1008 shown in FIG. 10 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1008 to enable configuration of the electrical structures and/or the logic gates to form circuits to perform desired operations/functions. The logic gate circuitry 1008 may include other electrical structures such as look-up tables (LUTs), registers (e.g., flip-flops or latches), multiplexers, etc.

The configurable interconnections 1010 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1008 to program desired logic circuits.

The storage circuitry 1012 of the illustrated example is structured to store result(s) of the one or more of the operations performed by corresponding logic gates. The storage circuitry 1012 may be implemented by registers or the like. In the illustrated example, the storage circuitry 1012 is distributed amongst the logic gate circuitry 1008 to facilitate access and increase execution speed.

The example FPGA circuitry 1000 of FIG. 10 also includes example dedicated operations circuitry 1014. In this example, the dedicated operations circuitry 1014 includes special purpose circuitry 1016 that may be invoked to implement commonly used functions to avoid the need to program those functions in the field. Examples of such special purpose circuitry 1016 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1000 may also include example general purpose programmable circuitry 1018 such as an example CPU 1020 and/or an example DSP 1022. Other general purpose programmable circuitry 1018 may additionally or alternatively be present such as a GPU, an XPU, etc., that can be programmed to perform other operations.

Although FIGS. 9 and 10 illustrate two example implementations of the programmable circuitry 812 of FIG. 8, many other approaches are contemplated. For example, FPGA circuitry may include an on-board CPU, such as one or more of the example CPU 1020 of FIG. 9. Therefore, the programmable circuitry 812 of FIG. 8 may additionally be implemented by combining at least the example microprocessor 900 of FIG. 9 and the example FPGA circuitry 1000 of FIG. 10. In some such hybrid examples, one or more cores 902 of FIG. 9 may execute a first portion of the machine readable instructions represented by the flowchart(s) of FIGS. 6-7 to perform first operation(s)/function(s), the FPGA circuitry 1000 of FIG. 10 may be configured and/or structured to perform second operation(s)/function(s) corresponding to a second portion of the machine readable instructions represented by the flowcharts of FIG. 6-7, and/or an ASIC may be configured and/or structured to perform third operation(s)/function(s) corresponding to a third portion of the machine readable instructions represented by the flowcharts of FIGS. 6-7.

It should be understood that some or all of the circuitry of FIG. 2 may thus, be instantiated at the same or different times. For example, same and/or different portion(s) of the microprocessor 900 of FIG. 9 may be programmed to execute portion(s) of machine-readable instructions at the same and/or different times. In some examples, same and/or different portion(s) of the FPGA circuitry 1000 of FIG. 10 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 900 of FIG. 9 may execute machine readable instructions in one or more threads executing concurrently and/or in series. In some examples, the FPGA circuitry 1000 of FIG. 10 may be configured and/or structured to carry out operations/functions concurrently and/or in series. Moreover, in some examples, some or all of the circuitry of FIG. 2 may be implemented within one or more virtual machines and/or containers executing on the microprocessor 900 of FIG. 9.

In some examples, the programmable circuitry 812 of FIG. 8 may be in one or more packages. For example, the microprocessor 900 of FIG. 9 and/or the FPGA circuitry 1000 of FIG. 10 may be in one or more packages.

In some examples, an XPU may be implemented by the programmable circuitry 812 of FIG. 8, which may be in one or more packages. For example, the XPU may include a CPU (e.g., the microprocessor 900 of FIG. 9, the CPU 1020 of FIG. 10, etc.) in one package, a DSP (e.g., the DSP 1022 of FIG. 10) in another package, a GPU in yet another package, and an FPGA (e.g., the FPGA circuitry 1000 of FIG. 10) in still yet another package.

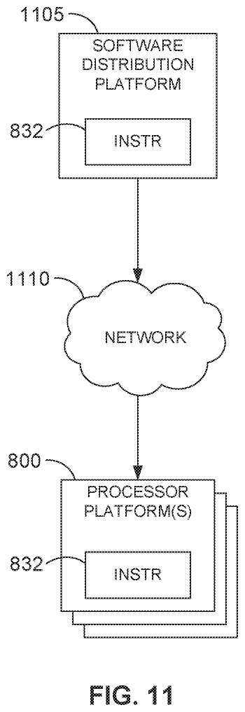

A block diagram illustrating an example software distribution platform 1105 to distribute software such as the example machine readable instructions 832 of FIG. 8 to other hardware devices (e.g., hardware devices owned and/or operated by third parties from the owner and/or operator of the software distribution platform) is illustrated in FIG. 11. The example software distribution platform 1105 may be implemented by any computer server, data facility, cloud service, etc., capable of storing and transmitting software to other computing devices. The third parties may be customers of the entity owning and/or operating the software distribution platform 1105. For example, the entity that owns and/or operates the software distribution platform 1105 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 1105 includes one or more servers and one or more storage devices. The storage devices store the machine readable instructions 832, which may correspond to the example machine readable instructions of FIGS. 6-7, as described above. The one or more servers of the example software distribution platform 1105 are in communication with an example network 1110, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 1105. For example, the software, which may correspond to the example machine readable instructions of FIG. 6-7, may be downloaded to the example programmable circuitry platform 800, which is to execute the machine readable instructions 832 to implement the inter-process communication circuitry. In some examples, one or more servers of the software distribution platform 1105 periodically offer, transmit, and/or force updates to the software (e.g., the example machine readable instructions 832 of FIG. 8) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B.

As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs).

For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that enable inter-process communication through use of a shared heap in a shared memory thereby greatly reducing and/or eliminating the need for marshalling and transmission of data by value. Disclosed systems, apparatus, articles of manufacture, and methods improve the efficiency of using a computing device by improving inter-process communication through use of a shared heap in a shared memory thereby greatly reducing and/or eliminating the need for marshalling and transmission of data by value. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to enable inter-process communication through use of a shared heap in a shared memory are disclosed herein. Further examples and combinations thereof include the following:

Example 1 includes At least one non-transitory machine-readable medium comprising machine-readable instructions to cause at least one processor circuit to at least cause sending of a request from a first process to a second process, the request to cause allocation of a shared heap in shared memory, determine a first virtual address range of the first process for the shared heap in the shared memory based on the first virtual address range matching a second virtual address range from the second process in the shared memory, and cause writing of information from the first process to the shared heap, the information to be accessed by the second process from the shared heap.

Example 2 includes the at least one non-transitory machine-readable medium of example 1, wherein the request is a first request, the machine-readable instructions to cause one or more of the at least one processor circuit to cause the sending of the first request to allocate the shared heap in response to a second request specifying at least one of an operation to be performed or a memory size.

Example 3 includes the at least one non-transitory machine-readable medium of example 2, wherein the machine-readable instructions are to cause one or more of the at least one processor circuit to perform the operation.

Example 4 includes the at least one non-transitory machine-readable medium of example 1, wherein the machine-readable instructions are to cause one or more of the at least one processor circuit to cause writing of data from the first process to an argument frame in the shared heap, the data corresponding to an operation to be performed by the second process.

Example 5 includes the at least one non-transitory machine-readable medium of example 4, wherein the machine-readable instructions are to cause one or more of the at least one processor circuit to access a result of the operation from the argument frame in the shared heap after the second process generates the result based on performing the operation.

Example 6 includes the at least one non-transitory machine-readable of example 5, wherein the machine-readable instructions are to cause one or more of the at least one processor circuit to cause writing of an address from the first process to a queue in the shared heap, the address to specify an address location of the argument frame in the shared heap for the second process, wherein the queue is an allocated portion of the shared heap and used to exchange a control message between the first process and the second process.

Example 7 includes the at least one non-transitory machine-readable medium of example 1, wherein the machine-readable instructions are to cause one or more of the at least one processor circuit to cause writing of a reference address from the first process to an argument frame in the shared heap, the reference address specifying a location in the shared heap that stores data corresponding to an operation to be performed by the second process.

Example 8 includes the at least one non-transitory machine-readable medium of example 1, wherein a third process shares the shared heap.

Example 9 includes an apparatus comprising memory, machine-readable instructions, at least one processor circuit to be programmed by the machine-readable instructions to cause sending of a request from a first process to a second process, the request to cause allocation of a shared heap in shared memory, determine a first virtual address range of the first process for the shared heap in the shared memory based on the first virtual address range matching a second virtual address range from the second process in the shared memory, and cause writing of information from the first process to the shared heap, the information to be accessed by the second process from the shared heap.

Example 10 includes the apparatus of example 9, wherein the request is a first request, and wherein one or more of the at least one processor circuit is to cause the sending of the first request to allocate the shared heap in response to a second request specifying at least one of an operation to be performed or a memory size.

Example 11 includes the apparatus of example 10, wherein one or more of the at least one processor circuit is to perform the operation.

Example 12 includes the apparatus of example 9, wherein one or more of the at least one processor circuit is to cause writing of data from the first process to an argument frame in the shared heap, the data corresponding to an operation to be performed by the second process.

Example 13 includes the apparatus of example 12, wherein one or more of the at least one processor circuit is to access a result of the operation from the argument frame in the shared heap after the second process generates the result based on performing the operation.

Example 14 includes the apparatus of example 13, wherein one or more of the at least one processor circuit is to cause writing of an address from the first process to a queue in the shared heap, the address to specify an address location of the argument frame in the shared heap for the second process, wherein the queue is an allocated portion of the shared heap and used to exchange a control message between the first Process and the second process.

Example 15 includes the apparatus of example 9, wherein the machine-readable instructions are to cause one or more of the at least one processor circuit to cause writing of a reference address from the first process to an argument frame in the shared heap, the reference address specifying a location in the shared heap that stores data corresponding to an operation to be performed by the second process.

Example 16 includes the apparatus of example 9, wherein a third process shares the shared heap.

Example 17 includes a method comprising sending of a request from a first process to a second process, the request to cause allocation of a shared heap in shared memory, determining, by at least one processor circuit programmed by at least one instruction, a first virtual address range of the first process for the shared heap in the shared memory based on the first virtual address range matching a second virtual address range from the second process in the shared memory, and causing, by one or more of the at least one processor circuit, writing of information from the first process to the shared heap, the information to be accessed by the second process from the shared heap.

Example 18 includes the method of example 17, including writing data from the first process to an argument frame in the shared heap, the data corresponding to an operation to be performed by the second process.

Example 19 includes the method of example 18, including accessing a result of the operation from the argument frame in the shared heap after the second process generates the result based on performing the operation.

Example 20 includes the method of example 19, including writing an address from the first process to a queue in the shared heap, the address to specify an address location of the argument frame in the shared heap for the second process, wherein the queue is an allocated portion of the shared heap and used to exchange a control message between the first process and the second process.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. At least one non-transitory machine-readable medium comprising machine-readable instructions to cause at least one processor circuit to at least:
cause sending of a request from a first process to a second process, the request to cause allocation of a shared heap in shared memory;
determine a first virtual address range of the first process for the shared heap in the shared memory based on the first virtual address range matching a second virtual address range from the second process in the shared memory; and
cause writing of information from the first process to the shared heap, the information to be accessed by the second process from the shared heap.

2. The at least one non-transitory machine-readable medium of claim 1, wherein the request is a first request, the machine-readable instructions to cause one or more of the at least one processor circuit to cause the sending of the first request to allocate the shared heap in response to a second request specifying at least one of an operation to be performed or a memory size.

3. The at least one non-transitory machine-readable medium of claim 2, wherein the machine-readable instructions are to cause one or more of the at least one processor circuit to perform the operation.

4. The at least one non-transitory machine-readable medium of claim 1, wherein the machine-readable instructions are to cause one or more of the at least one processor circuit to cause writing of data from the first process to an argument frame in the shared heap, the data corresponding to an operation to be performed by the second process.

5. The at least one non-transitory machine-readable medium of claim 4, wherein the machine-readable instructions are to cause one or more of the at least one processor circuit to access a result of the operation from the argument frame in the shared heap after the second process generates the result based on performing the operation.

6. The at least one non-transitory machine-readable of claim 5, wherein the machine-readable instructions are to cause one or more of the at least one processor circuit to cause writing of an address from the first process to a queue in the shared heap, the address to specify an address location of the argument frame in the shared heap for the second process, wherein the queue is an allocated portion of the shared heap and used to exchange a control message between the first process and the second process.

7. The at least one non-transitory machine-readable medium of claim 1, wherein the machine-readable instructions are to cause one or more of the at least one processor circuit to cause writing of a reference address from the first process to an argument frame in the shared heap, the reference address specifying a location in the shared heap that stores data corresponding to an operation to be performed by the second process.

8. The at least one non-transitory machine-readable medium of claim 1, wherein a third process shares the shared heap.

9. An apparatus comprising:
memory;
machine-readable instructions;
at least one processor circuit to be programmed by the machine-readable instructions to:
cause sending of a request from a first process to a second process, the request to cause allocation of a shared heap in shared memory;
determine a first virtual address range of the first process for the shared heap in the shared memory based on the first virtual address range matching a second virtual address range from the second process in the shared memory; and
cause writing of information from the first process to the shared heap, the information to be accessed by the second process from the shared heap.

10. The apparatus of claim 9, wherein the request is a first request, and wherein one or more of the at least one processor circuit is to cause the sending of the first request to allocate the shared heap in response to a second request specifying at least one of an operation to be performed or a memory size.

11. The apparatus of claim 10, wherein one or more of the at least one processor circuit is to perform the operation.

12. The apparatus of claim 9, wherein one or more of the at least one processor circuit is to cause writing of data from the first process to an argument frame in the shared heap, the data corresponding to an operation to be performed by the second process.

13. The apparatus of claim 12, wherein one or more of the at least one processor circuit is to access a result of the operation from the argument frame in the shared heap after the second process generates the result based on performing the operation.

14. The apparatus of claim 13, wherein one or more of the at least one processor circuit is to cause writing of an address from the first process to a queue in the shared heap, the address to specify an address location of the argument frame in the shared heap for the second process, wherein the queue is an allocated portion of the shared heap and used to exchange a control message between the first Process and the second process.

15. The apparatus of claim 9, wherein the machine-readable instructions are to cause one or more of the at least one processor circuit to cause writing of a reference address from the first process to an argument frame in the shared heap, the reference address specifying a location in the shared heap that stores data corresponding to an operation to be performed by the second process.

16. The apparatus of claim 9, wherein a third process shares the shared heap.

17. A method comprising:
sending of a request from a first process to a second process, the request to cause allocation of a shared heap in shared memory;
determining, by at least one processor circuit programmed by at least one instruction, a first virtual address range of the first process for the shared heap in the shared memory based on the first virtual address range matching a second virtual address range from the second process in the shared memory; and
causing, by one or more of the at least one processor circuit, writing of information from the first process to the shared heap, the information to be accessed by the second process from the shared heap.

18. The method of claim 17, including writing data from the first process to an argument frame in the shared heap, the data corresponding to an operation to be performed by the second process.

19. The method of claim 18, including accessing a result of the operation from the argument frame in the shared heap after the second process generates the result based on performing the operation.

20. The method of claim 19, including writing an address from the first process to a queue in the shared heap, the address to specify an address location of the argument frame in the shared heap for the second process, wherein the queue is an allocated portion of the shared heap and used to exchange a control message between the first process and the second process.
